(19) United States
(12) Patent Application Publication
(10) Pub. No.: US 2006/0013160 A1
(43) Pub. Date: Jan. 19, 2006

(54) Peer connectivity in ad-hoc communications systems

(76) Inventor: Jacobus C. Haartsen, Hardenberg (NL)

Correspondence Address: POTOMAC PATENT GROUP, PLLC, P. O. BOX 270, FREDERICKSBURG, VA, 22404, US

(21) Appl. No.: 11/018,586

(22) Filed: Dec. 21, 2004

Related U.S. Application Data
(60) Provisional application No. 60/588,754, filed on Jul. 19, 2004.

(51) Int. Cl. H04Q 7/00

(52) U.S. Cl. 370/328

(57) ABSTRACT

A terminal that is capable of communicating on a first system that is an ad-hoc communication system, and a second system that is a mobile communication system is operated by receiving one or more dynamically changing values from a network part of the second system; and using the one or more dynamically changing values to determine one or more parameters that characterize one or more ad-hoc communication operations in the first system. The ad-hoc communication operations may, for example, be an inquiry operation, a paging operation, and a scanning operation. The one or more parameters that characterize these operations may include when the operation will occur, and on what frequency it will be carried out. The dynamically changing values may include a clock value and/or a frame counter value. In this way, timing and/or frequency uncertainty may be eliminated when performing the operations in the first system.

### CROSS REFERENCE TO RELATED APPLICATIONS

This application claims the benefit of U.S. Provisional Application No. 60/588,754, filed Jul. 19, 2004, which is hereby incorporated herein by reference in its entirety.

### BACKGROUND

The invention relates to radio communication, and more particularly, it relates to efficient methods and apparatuses for establishing connections in a wireless, ad-hoc communication system.

In the last few decades, progress in radio and Very Large Scale Integrated Circuit (VLSI) technology has fostered widespread use of radio communications in consumer applications. Portable devices, such as mobile radios, can now be produced having acceptable cost, size and power consumption. Consumers have largely benefited from the progress in radio technology. Mobile telephony has achieved large market penetration, allowing users to access the telephone network via their portable terminals. Mobile systems cover large areas providing Wide Area Networking (WAN). Examples of mobile telephony systems that are deployed worldwide are the Global System for Mobile communication (GSM), the Code Division Multiple Access 2000 system (CDMA2000) and the Universal Mobile Telecommunications System (UMTS). Wireless communication is also extensively used in the enterprise market. In the office environment, wireless access to the corporate network allows users to move around with their laptops without the inconvenience of cables and connectors. This wireless access replaces conventional Local Area Networks (LANs) based on Ethernet. An example of a Wireless LAN (WLAN) system that is widely deployed, is that standardized under IEEE 802.11 (including its derivatives like 802.11b, 802.11a, and 802.11g).

The WAN and WLAN systems described above are examples of access systems: they provide access to a (fixed) network, such as the telephone network for mobile telephony or the corporate network for WLAN. Portable terminals or equipment like laptop computers access the network via fixed access points (APs) or base stations (BSs). These are advanced radio transceivers positioned at strategic positions to give optimal coverage. The APs or BSs define a cell within which the mobile terminals can freely move while remaining connected. In a cellular structure, multiple base stations cover a large area with multiple (partly overlapping) cells. As a mobile terminal moves from one cell to another, its connection is handed off seamlessly from one cell to the other.

The access systems described above offer a very coordinated environment. The AP or BS controls the selection of channels (frequencies, time slots, or spreading codes or a combination thereof depending on whether the multiple access scheme is Frequency Division Multiple Access (FDMA), Time Division Multiple Access (TDMA), or Code Division Multiple Access (CDMA)). Central stations (Base Station Controllers (BSCs) or Mobile Telephone Switching Offices (MTSOs)) control the channel allocation, preventing interference between communications within the cell, and between communications carried out in adjacent or neighboring cells. The AP or BS also determines which terminal gets access and when.

More recently, a new type of radio system has started to be deployed that is not based on access technology. This radio system is intended to provide wireless connections directly between mobile or portable devices. There is no AP or BS, nor is there an access to a (fixed) network. Instead, devices in such a system can spontaneously establish a connection between themselves. This is referred to as ad-hoc networking. This kind of communication started out being used by the military, and by police and fire fighters. For consumers, the walky-talky existed, but this had only limited applicability as it only connected two units. Some years ago, a new radio system was developed that was optimized for ad-hoc connectivity for commercial usage. This system, called the Bluetooth® wireless system, is now widely deployed in consumer products like mobile phones, headset, laptop computers, PCs, keyboards, mice, and the like.

Ad-hoc communications lack the control and coordination provided by access technologies. Two units that come into range can spontaneously establish a connection. However, they have to determine autonomously what channel to use. Also the control of the channel (e.g., which unit gets access to this channel and when) must be determined autonomously. Preferably, radio spectrum should be used that can be used worldwide, since there is no way of controlling the transmission of these ad-hoc radios. A suitable band is the Industrial, Scientific and Medical (ISM) band at 2.45 GHz, which is globally available. The band provides 83.5 MHz of radio spectrum.

To allow different radio networks to share the same radio medium without coordination, signal spreading is usually applied. Spreading can either be at the symbol level by applying direct-sequence (DS) spread spectrum methodology or at the channel level by applying frequency hopping (FH) spread spectrum methodology. The latter is attractive for the radio applications mentioned above since it more readily allows the use of cost-effective radios.

As mentioned above, the Bluetooth® system has been developed to provide pervasive connectivity especially between portable devices like mobile phones, laptops, PDA, and other nomadic devices. This system applies frequency hopping to enable the construction of low-power, low-cost radios with a small footprint. The system supports both data and voice. The latter is optimized by applying fast frequency hopping with a nominal rate of 1600 hops/s through the entire 2.4 GHz ISM band in combination with a robust voice coding. The air interface uses time slots with a nominal length of 625 μs, which corresponds to the dwell time of the FH scheme. A single packet can be sent during a time slot.

Devices based on the Bluetooth® system concept can create so called piconets, which consist of a master device and one or more slave devices connected via the FH piconet channel. The FH sequence used for the piconet channel is completely determined by the address or identity of the device acting as the master. The system clock of the master device determines the phase in the hopping sequence. In the Bluetooth® system, each device has a free-running system clock. The slave devices add a time offset to their clocks to put them into alignment with the clock of the master device. By using the master address to select the proper hopping sequence and using the time offset to align to the master clock, the slave devices keep in hop synchrony to the master device; that is, master and slave devices remain in contact by hopping synchronously to the same hop frequency or hop carrier. For more details, the reader is referred to “The Bluetooth radio system,” by J. C. Haartsen, published in IEEE Personal Communications Magazine, Vol. 7, No. 1, February 2000, pp. 28-36.

Crucial for ad-hoc communication systems is a mechanism for connection establishment: how the units find each other and how the initial connection setup is carried out. The standards for Bluetooth® technology have defined an inquiry procedure and a paging procedure for initially setting up the connection. During the inquiry procedure, a unit can discover which other Bluetooth® units are in range. With the information collected during the inquiry process, the inquiring unit can then page one of the “discovered” units to set up a connection.

During startup, contradictory requirements are presented. On the one hand, units that are idle should consume very little current. This can only be accomplished when the unit in idle mode sleeps most of the time (i.e., all of its activity is suspended). But this prevents a fast response time, and thus increases the latency (i.e., the time it takes the unit to respond). Clearly, there is a trade-off between current consumption and latency. In a radio environment, the procedure is further complicated by uncertainties in frequency and time. Normally, the radio spectrum is divided into smaller frequency bands (for Bluetooth® technology, 79 channels, each 1 MHz wide, have been defined in the 2.4 GHz ISM band). The frequency band in which the first communication will start is left undefined. Thus, the question is raised: On which frequency will the paging/inquiring unit transmit and on which frequency will the idle unit scan? They can only meet when they transmit and receive on the same frequency. In addition, it is undefined at which point in time the paging/inquiring unit will transmit and at which point in time the idle unit will scan. Again, they can only meet when they respectively transmit and receive simultaneously. These uncertainties in time and frequency are a consequence of the lack of a central controller and a lack of coordination in general. The larger the frequency-time uncertainty, the longer time or the more power it takes in order to get two units connected.

In Bluetooth® systems, the burden of connection establishment and solving the time-frequency uncertainty has been placed on the pager/inquirer. The reasoning is that a unit is idle most of the time. The battery time for idle units shall therefore be optimized. Details on the initial setup in Bluetooth® systems can be found in the U.S. Pat. No. 5,940,431 (“Access technique of channel hopping communications system”) issued on Aug. 17, 1999 to J. C. Haartsen. As described therein, each Bluetooth® unit operating in idle mode wakes up regularly to listen on a particular frequency carrier for a page message corresponding to its own identity (Bluetooth Device Address or BD_ADDR) when in page scan mode, or to a common inquiry message when in inquiry scan mode. There are 32 different frequencies the idle unit can listen to, but it listens only to one of these during any given wake-up instant. In the next wake-up instant, it listens to the next frequency, and so on. The unit that wants to make contact (i.e., the paging unit) does not know when the idle unit will wake up and on which frequency. It therefore repeatedly sends the page message sequentially on different frequencies. When the paging unit hops at a 3200 hops/s rate, it takes 10 ms to hop through all the 32 frequencies. If the idle unit listens for at least 10 ms on one of these frequencies, it will certainly receive the access code because one of the paging unit's transmissions will coincide with the frequency the idle unit is listening on. The actual connection setup scheme is a little more complicated than described here (e.g., the 32 frequencies are split into two trains of 16 carriers each by the paging unit) and the interested reader is further referred to the article “The Bluetooth radio system,” by J. C. Haartsen mentioned above, or to the Bluetooth specifications.

The page message includes an access code. The access code contains a special symbol sequence known to have good auto- and cross-correlation properties. The access code is related to the BD_ADDR of the recipient. When the idle unit receives the proper access code, it returns a signal, which again includes this same access code, back to the paging unit to confirm the reception. In order to be able to receive this confirmation, the paging unit listens in-between its own transmissions. Once the two access codes are exchanged as a handshaking operation, the two units are in FH synchronization. In the next packet sent by the paging unit, more synchronization information is included in order to move to a hopping sequence that uses all 79 carriers available in the 2.4 GHz band.

Recently, new applications for ad-hoc connectivity have been developed that put more stringent requirements on the inquiry/paging process. These applications are typically carried out in the background without any user interaction or explicit event (which could otherwise start the inquiry/paging processes). These applications require that two units establish a connection as soon as they come into each other's range. An example is matchmaking or mobile dating as described in the CNN.com article entitled “Wanted: New friend, must have Bluetooth” and posted on Jun. 23, 2004 at the following World Wide Web site: http://www.cnn.com/2004/TECH/ptech/06/23/telecoms.singapore.friends.reut/.

As described in the article, a user programs his or her mobile phone to look for a person with certain characteristics which are summarized in a profile. Via a short-range wireless radio link (e.g., Bluetooth®), the mobile phone probes its environment for mobile phones whose owner corresponds to the profile. When the profiles match, the phones alert the users via an audible or vibrating signal. In a variant on the service, the user's profile describes an item that the person desires to purchase. The user is alerted when he or she comes within range of a seller of an item matching the purchase criteria.

These are examples of pure peer-to-peer applications. In such applications, multiple devices continuously look for each other. Consequently, a unit engaged in such an application has to carry out both inquiry/paging and scanning. This puts quite a burden on the power consumption of the unit. Reasonable latency figures (a couple of seconds) are required, as units may not be within range of one another for a long time (e.g., pedestrians passing each other on the street). On the other hand, units cannot transmit or receive continuously as that would drain the battery. Bluetooth® units in idle mode typically wake up every 1.28 s for a period of about 11 ms. This is a duty cycle of less than 1%. The inquiry process in Bluetooth® devices may take a few seconds. But that requires the inquirer to transmit continuously. If a duty cycle of less than 1% were only required of the inquiring unit, the inquirer would for example be active for 5 s out of every 500 s. This means that the latency would increase to 500 s or about 9 minutes. Such a long latency might be too long to make applications such as the matchmaking application described above feasible.

To speed up the connection establishment process, one could reduce the uncertainty in time or in frequency. Reducing the uncertainty in time would result in units transmitting and/or scanning more often. This would detrimentally affect the current consumption. It would also introduce wasteful transmissions in the radio spectrum which would present interference to other radio systems operating in this band.

Reducing the uncertainty in frequency could be accomplished by using fewer channels. This would affect the robustness of the system, because when the channel is jammed, no connection could be initiated. In addition, it may not be permitted by regulations. For example, the FCC in the United States and the ETSI in Europe require units that apply frequency hopping to use at least 15 hop frequencies, even during startup.

There is thus a clear need to improve the connection setup procedures in ad-hoc systems for peer applications that operate in the background.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Methods and apparatuses operate a terminal that is capable of communicating on a first system that is an ad-hoc communication system, and a second system that is a mobile communication system. In accordance with one aspect of the present invention, operating the terminal includes receiving one or more dynamically changing values from a network part of the second system; and using the one or more dynamically changing values to determine one or more parameters that characterize one or more ad-hoc communication operations in the first system.

In some embodiments, the one or more dynamically changing values include a clock value received from the network part of the second system. Alternatively, or in addition, the dynamically changing values include a frame counter value received from the network part of the second system.

In another aspect, using the one or more dynamically changing values to determine the one or more parameters that characterize one or more ad-hoc communication operations in the first system includes using the one or more dynamically changing values to determine when an ad-hoc communication establishment operation will occur. Alternatively or in addition, the one or more dynamically changing values may be used to determine a frequency to be used by the ad-hoc communication establishment operation.

The ad-hoc communication establishment operation may, for example, be a scan operation. In another aspect relating to such embodiments operating the terminal includes performing the scan operation, wherein the scan operation has a duration that is approximately equal to the duration of one inquiry message.

In other embodiments involving scan operations, operating the terminal includes performing the scan operation and as a result receiving an inquiry message; determining that a response message should be transmitted in response to the inquiry message; and selecting one of two or more candidate response time slots for use in transmitting the response message.

In yet another aspect, selecting one of the two or more candidate response time slots utilizes a random selection technique.

In still other embodiments involving scan operations, operating the terminal includes performing the scan operation and as a result receiving an inquiry message; determining that a response message should be transmitted in response to the inquiry message; and using a random access scheme (e.g., a contention-based scheme) to transmit the response message in a response time slot.

In alternative embodiments in which the ad-hoc communication establishment operation is a scan operation, operating the terminal includes randomly selecting a number, L, representing how many inquiry messages with a same identity must be received before a response message is sent. In another aspect of such embodiments, operation of the terminal further comprises detecting L occurrences of an inquiry message with the same identity, and in response to said detection, transmitting a response message in a response time slot occurring after the L:th inquiry message with the same identity.

In alternative embodiments, the ad-hoc communication establishment operation may be an inquiry operation.

An aspect of such embodiments involves the terminal being operated to perform the inquiry operation, wherein the inquiry operation has a duration that is approximately equal to the duration of one inquiry message.

In still another aspect, using the one or more dynamically changing values to determine the one or more parameters that characterize one or more ad-hoc communication operations in the first system includes using the one or more dynamically changing values to determine when the inquiry operation will occur. In some embodiments, this includes determining a set of two or more candidate wake-up event times; selecting one of the two or more candidate wake-up event times for use as a wake-up time when the inquiry operation will occur; and designating all remaining ones of the set of two or more candidate wake-up event times as times when the inquiry operation will not be performed. In alternative embodiments, this includes assigning a probability 1/N that represents a frequency with which the inquiry operation will occur; and at each occurrence of a candidate wake-up event time, randomly determining whether to perform the inquiry operation such that the inquiry operation will be performed, on average, 1/N of the times that the random determination is made.

In yet another aspect, selecting one of the two or more candidate wake-up event times utilizes a random selection technique.

In still other embodiments, the ad-hoc communication establishment operation is a paging operation. An aspect of these embodiments has the terminal being operated to perform the paging operation, wherein the paging operation has a duration no longer than the duration of one paging message.

In another aspect, using the one or more dynamically changing values to determine the one or more parameters that characterize one or more ad-hoc communication operations in the first system includes using the one or more dynamically changing values to determine when the paging operation will occur. In some embodiments, this includes determining a set of two or more candidate wake-up event times; selecting one of the two or more candidate wake-up event times for use as a wake-up time when the paging operation will occur; and designating all remaining ones of the set of two or more candidate wake-up event times as times when the paging operation will not be performed.

In another aspect, selecting one of the two or more candidate wake-up event times utilizes a random selection technique.

In still another aspect, determining when the paging operation will occur includes using the one or more dynamically changing values to determine when an inquiry operation will occur; and determining that the paging operation will occur a predetermined time after the time determined for performing the inquiry operation.

In yet other embodiments, operation of the terminal involves, while continuing to participate in the first system, using the one or more dynamically changing values to determine one or more parameters that characterize one or more ad-hoc communication operations in a third system, wherein the third system is an ad-hoc communication system.

In some embodiments, using the one or more dynamically changing values to determine the one or more parameters that characterize one or more ad-hoc communication operations in the first system comprises using the one or more dynamically changing values to determine a time slot alignment within the first system; and using the one or more dynamically changing values to determine the one or more parameters that characterize one or more ad-hoc communication operations in the third system comprises using the one or more dynamically changing values to determine a time slot alignment within the third system. This is useful, for example, to align the time slots between the first system and the third system.

In another aspect, using the one or more dynamically changing values to determine the one or more parameters that characterize one or more ad-hoc communication operations in the first system comprises using the one or more dynamically changing values to determine a hop sequence within the first system; and using the one or more dynamically changing values to determine the one or more parameters that characterize one or more ad-hoc communication operations in the third system comprises using the one or more dynamically changing values to determine a hop sequence within the third system. With this feature it is possible, for example, to ensure that the hop sequence within the first system and the hop sequence within the third system are orthogonal to one another.

In still another aspect, the terminal can perform as a slave in both the first and third systems. Alternatively, the terminal can perform as a master in the first system while concurrently performing as a slave in the third system.

### BRIEF DESCRIPTION OF THE DRAWINGS

The objects and advantages of the invention will be understood by reading the following detailed description in conjunction with the drawings in which:

FIG. 1 illustrates a matchmaking application in mobile telephones.

FIG. 2 is a schematic diagram of a cellular network including mobile terminals.

FIG. 3 is a block diagram of an exemplary terminal architecture according to an embodiment.

FIG. 4 is an exemplary timing diagram of ad-hoc radio operation according to an embodiment.

FIG. 5 is an exemplary format of an inquiry message according to an embodiment.

FIG. 6 is an exemplary timing diagram of the inquiry response procedure according to an embodiment.

FIG. 7 is an exemplary high-level flow diagram of operations that are performed in a terminal unit in accordance with a number of aspects of the invention.

FIG. 8a is a timing diagram of various transmissions taking place between a slave and each of two piconets that the slave is participating in.

FIG. 8b is a timing diagram of various transmissions taking place between a slave and each of two synchronized piconets that the slave is participating in.

FIG. 8c is a schematic diagram of a cellular network including mobile terminals in which a slave is active in two piconets.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

This disclosure presents methods and apparatuses that enable mobile communication devices to find one another via a short-range radio without compromising on latency and robustness, while providing considerable improvement in current consumption performance. An overview of some aspects of these methods and apparatuses is now presented.

Power consumption for peer finding applications can be improved considerably when there is a common timing reference. This timing reference can solve both the timing uncertainty and the frequency uncertainty. In mobile telephones, such a common timing reference is present in the cellular network itself. More particularly, mobile telephones are locked to a base station. The clocks in the cellular terminal are accurately synchronized to the clock in the cellular base station. By deriving the time instants and frequencies for scanning and inquiry/page transmissions in the ad-hoc network from this single reference, there is no uncertainty in time or frequency in the communications unit when initiating a short-range connection. At the wake-up instant, the scan window only needs to cover the duration of the inquiry/page message, and the inquiry/page message only needs to be a single message on a single frequency. Duty cycles of less than 0.05% can be achieved while still providing latency figures on the order of a few seconds.

In another aspect, as will be further described below, repeated collisions on the inquiry messages can be prevented by randomizing the transmission of these messages between a number of wake-up instances. The response to the inquiry messages should also be randomized in order to prevent repeated collisions of units that respond to the same inquirer.

In still another aspect, inquiry messages are tagged with an identity associated with the inquiring unit. A unit that has responded to an inquiry message should abstain from responding to this same inquiry message again (recognized by the tagged identity) for a certain period of time.

In yet another aspect, the clock from the cellular system (e.g., the frame counter) or other timing reference provider, can be used to select the frequency that the scanner and the pager/inquirer are using at each wake-up instant. It is preferred that, as the frame counter is incremented over time, the terminals continuously choose a different frequency at each wake-up instant in order to provide robustness.

These and other aspects will now be described in greater detail in the following discussion. To facilitate the reader's understanding, the various aspects are described with reference to Bluetooth® technology, which is well-known. It should be appreciated, however, that the inventive concepts disclosed here are not limited to application only in Bluetooth® systems. Rather, those of ordinary skill in the art will recognize that these same concepts may be applied in other systems that share the pertinent characteristics (e.g., lack of a common timing and/or frequency reference for units in an ad-hoc network) described herein with respect to Bluetooth® technology.

Since the launch of commercial Bluetooth® products in 1999, the number of applications using this technology has continuously risen and the deployment is intensifying as well. Ad-hoc communications for personal use are becoming a daily routine. A great number of Bluetooth® chipsets are being incorporated in mobile communication devices such as mobile phones. It is no wonder, then, that most of the Bluetooth®-related applications center around the mobile phone. Mobile phones connect wirelessly to their accessories via Bluetooth® technology; examples are wireless headsets, car kits, personal digital assistants (PDAs) and laptop computers. There has also been an increase in the use of Bluetooth® technology for enabling direct communication between mobile phones. The exchange of ring tones, pictures, and also gaming are just a few examples.

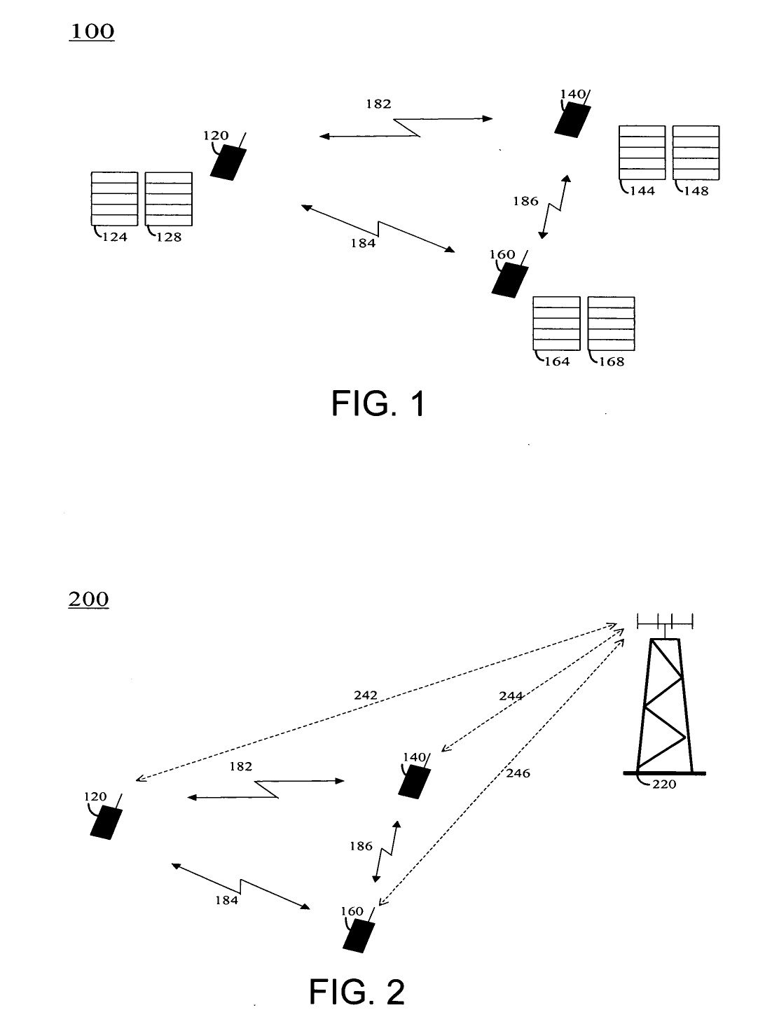

Another inter-terminal application is matchmaking. The matchmaking application is illustrated in FIG. 1. Shown are three terminals 120, 140, and 160. A matchmaking (software) program runs at the application level within each of the terminals 120, 140, 160. The owner of terminal 120 has to fill in two lists: a preference list 124 and a status list 128. The owners of terminals 140 and 160 likewise each fill in two lists: a preference list 144, 164 and a status list 148, 168. Each of the preference lists 124, 144, 164 is a wish list of characteristics that the owner of the terminal would like to see in a person he or she meets (e.g., for dating or to meet friends with common interests). Each of the status lists 128, 148, 168 is a list with characteristics of the user himself or herself. The preference list and status list could be the same, so a single list results (not shown). Types of information included in the list(s) 124, 128, 144, 148, 164, 168 could, for example include gender (male/female), body features (height, weight), age, preferred music, preferred food, preferred sport, and so on.

In this example, suppose that the units 120 and 140 come within each other's range. In response, the lists 124, 128 and 144, 148 are exchanged via an ad-hoc, wireless connection 182 (e.g., a Bluetooth® connection) typically operating in the 2.4 GHz ISM band. A comparison is then made in each terminal. If there is a match in all items or in a sufficient number of (prioritized) items, the terminal alerts the owner via an audible or vibrating signal. Alternatively, only the wish lists are exchanged. Comparisons are done at both sides (e.g., at each of terminals 120 and 140). If the preference list matches with the status list, the terminal 120, 140 associated with the status list 128, 148 may produce an audible and/or vibrating signal, and may send a signal via the radio link 182 to the other unit that in turn may produce an audible and/or vibrating signal to alert its owner of the match. After the alert, the owners can then take action to meet each other in person.

When turned on, the mobile terminal is part of a network. After scanning the cellular air interface (for example the 900 MHz or 1800 MHz bands for a terminal operating within a GSM system; or the 2000 MHz band for a terminal operating within the UMTS system) for control channels broadcast by cellular base stations, the mobile terminal will lock on to one control channel (usually the control channel with the strongest signal level) and enter an idle mode. In this idle mode, the terminal is mostly in a sleep state. Periodically, it wakes up to monitor the control channel, in particular the paging channel, to determine whether there are pending messages (incoming calls).

FIG. 2 is a schematic diagram showing the same terminals 120, 140, and 160 as in FIG. 1, but here they are also locked on to a cellular base station 220. It is very likely that the terminals 120, 140, 160 will be locked to the same base station 220 when the separation between the terminals 120, 140, 160 is small (e.g., up to a few tens of meters, which happens to be about the maximum distance in order for the terminals 120, 140, 160 to be within range of one another to establish and maintain the short-range connections 182, 184, and 186). The terminals 120, 140, 160 are locked on to the base station 220 via respective individual cellular channels 242, 244, and 246. These cellular channels could be one and the same channel when the terminals 120, 140, 160 are locked to the broadcast channel (BCH) of the base station 220. The clocks in the cellular transceivers of the terminals 120, 140, 160 are within a 0.1 ppm accuracy with respect to the base station clock. Because it is highly likely that all terminals 120, 140, 160 are synchronized to the same base station, it is also highly likely that they are also synchronized among each other. By providing this clock information from the cellular radio in the terminal to the short-range radio (also within the terminal), the peer finding technique in the short-range radio can be improved considerably.

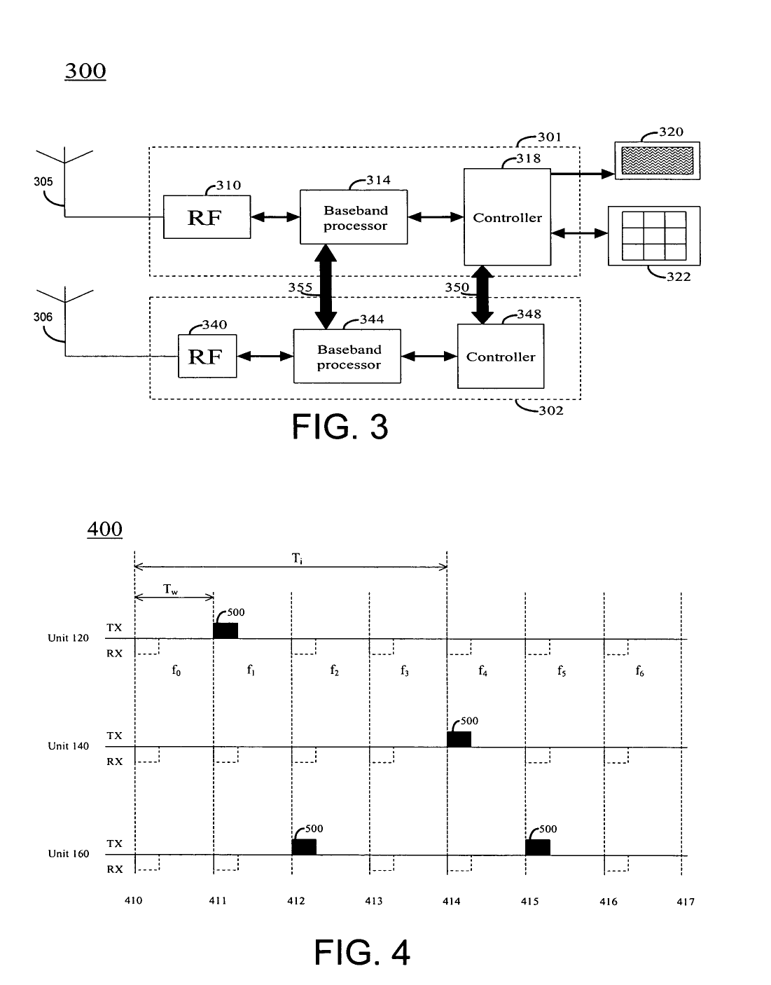

An exemplary embodiment of a general architecture of a cellular terminal 300, including a short-range radio transceiver 302 is shown in FIG. 3. The cellular transceiver 301 within the terminal 300 comprises a radio frequency (RF) part 310 which is coupled to an antenna 305 and a baseband processor 314. The baseband processor 314 is coupled to a controller 318. The controller 318 interfaces to a Man-Machine-Interface (MMI), such as a display 320 and input keys 322. The short-range radio transceiver 302, also within the terminal 300, comprises similar components: an RF part 340 is coupled to an antenna 306 and a baseband processor 344. The baseband processor 344 is coupled to a control section 348.

The controller sections 318 and 348 of the respective cellular transceiver 301 and short-range radio transceiver 302 interact with each other via interface 350. There may also be an interface 355 between the baseband processors 314, 344. The timing information of the cellular system resides in the controller 318 (alternatively, it may reside in the baseband processor 314). This timing information has a resolution of less than one microsecond. The cellular timing information is transferred from the cellular transceiver 301 to the short-range transceiver 302 via the interface 355 (or alternatively interface 350) to time the scanning and inquiry/page procedures.

In addition to timing information, the cellular system also provides counter information. In the GSM system, each 8-slot frame is numbered with a 22-bit frame number; the GSM frame duration is 4.615 ms. In UMTS, each frame is numbered with a 12-bit frame number; the UMTS frame duration is 10 ms. For every new frame (occurring every 4.615 ms for GSM and every 10 ms for UMTS), the frame number is incremented. This frame number is sent by the base stations to the terminals via the broadcast channel. The frame number is stored and updated in the terminals as it schedules transmit and receive events (e.g., when to wake up to monitor the paging channel). In another aspect of this embodiment, the frame number is also transferred from the cellular transceiver 301 to the short-range transceiver 302 via interface 350 (or interface 355). This frame number can be used to select the frequency on which the scanning and inquiry/paging procedures are carried out, thereby eliminating the frequency uncertainty from these procedures.

The timing and clock information provided by the cellular transceiver section 301 to the short-range transceiver section 302 is used as follows in the short-range radio system. The timing information can accurately determine wake-up events that are scheduled at a fixed interval T_{w}. Furthermore, an inquiry interval Tᵢ is determined where Tᵢ=N×T_{W} with N being an integer. The value Tᵢ determines the compromise between latency on the one hand, and power consumption and wasteful transmissions on the other hand. A small value of Tᵢ gives better latency but results in more power consumption and more interference.

In another aspect of this embodiment, the inquiry transmissions are randomized in order to avoid repeated transmissions of inquiry messages sent by different units. (As used throughout this disclosure (including the claims), the term “random” and its variants shall be construed to cover all possibilities of truly random and pseudorandom.) Every Tᵢ interval, a unit can select one out of N wake-up events to transmit an inquiry message. On the remaining (i.e., unselected) wake-up events, the unit just listens to the channel. The number N should therefore be chosen large enough to minimize the probability of collision in an environment where there are a large number of units. If there are m units, the probability of success is

$${P}_{success} = {( 1 - \frac{1}{N} )}^{m}$$

In practice, P_{success} will be higher since not all collisions result in a failure.

An alternative way to randomize the inquiry messages is to assign a probability to the inquiry operation, for example, 1 out of N. For each new event time, whether the inquiry operation is carried out is based on a random selection such that the inquiry operation takes place once out of every N times that the decision is made whether to perform the inquiry operation. On average, this gives the same result as the other random technique described above, but the distribution is a little different (e.g., the probability of three or more inquiry operations in a row is zero with the first-described technique, but is

$${( \frac{1}{N} )}^{3}$$

if probabilities are assigned as just described.

FIG. 4 is an exemplary timing diagram of ad-hoc radio operation for the three exemplary terminals 120, 140, and 160 according to an embodiment. For the example shown, it is assumed that Tᵢ=4 s and N=4. In practice, it may be preferable to use a larger value of Tᵢ and a larger value of N. With the assumed values, however, the wake-up interval is then also determined to be T_{w}=Tᵢ/N=1 s.

Every second, the short-range radio within each of the terminal units 120, 140, 160 wakes up. At each wake-up event, a terminal unit will either listen for an inquiry with the terminal unit's access code (with the act of listening being represented by the dotted lines on the receive (RX) side of the horizontal axis) or transmit an inquiry message 500 (represented by the solid rectangle on the transmit (TX) side of the axis). At the first wake-up event 410, all units are listening. If there is no message (as there isn't in this example), they can return to sleep. At the second wake-up event 411, terminal unit 120 transmits in inquiry message 500. Terminal units 140 and 160 may respond or abstain as will be clarified later. At the third wake-up event 412, terminal unit 160 transmits an inquiry message 500 and terminal units 120 and 140 may respond or abstain, and so on.

When two units transmit an inquiry message simultaneously, propagation conditions will determine whether one of the messages will be successfully received by the other unit. If both transmissions fail, the system just has to wait for the next wake-up event to continue. If one transmission succeeds, the receiving unit may respond to that transmission. On average, a terminal unit transmits an inquiry message in one out of every N=4 wake-up events. In this example, this is on average one occurring every 4 s. When no inquiry message is sent, the terminal unit only listens.

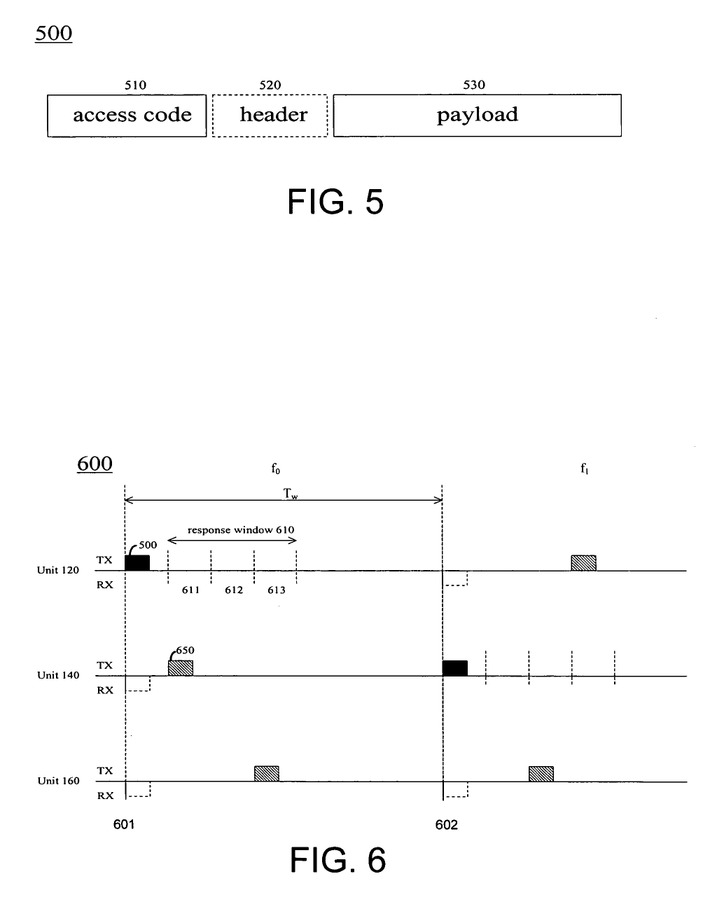

The inquiry message itself can have a very simple format. FIG. 5 illustrates an exemplary format of an inquiry message 500. In the example, the inquiry message 500 includes an access code 510, possibly a header 520 (but not required), and a payload 530. The access code 510 is a bit sequence with good synchronization properties. The header 520 may not be needed. The payload 530 contains information that in some way identifies the inquirer. The identity may, for example, be a fixed identity (like the BD_ADDR in the Bluetooth® system), or it may alternatively be a number randomly chosen by the inquirer. This random number should be long enough that the probability of two units nearby selecting the same random number is very small. In addition, the random identity may be changed once in a while (for example every few hours).

If it is desired to keep the format of the inquiry message as close as possible to formats used in the Bluetooth® system, a packet format very similar to the frequency hopping synchronization (FHS) packet should be chosen with the identity in the payload. Preferably, the message is much shorter than the FHS packet. One possibility is a message made up of the 72-bit inquiry access code used in Bluetooth® and a payload containing a random identity of 24 bits.

It is assumed that the Bluetooth® radio is used with a peak bit rate of 1 Mb/s. Units that scan open a receive window 72 μs in order to listen for the inquiry access code. The received signal is then correlated with the known inquiry access code. If no match is found, the terminal unit returns to sleep until the next wake-up event. If a match is found (the number of corresponding bits exceeds a certain threshold), the identity in the payload is read as well. There are then two ways for the unit to proceed. If this identity has not been encountered before, the response procedure is carried out. An exemplary response procedure is described later in this description. If the response procedure is successful and the inquirer and the respondent exchange information (after the page procedure), the respondent stores the inquirer's identity in memory in a list of identities it has met before. Preferably, the stored identities will have a limited lifetime, for example a few hours. If identities have been residing in memory for at least the predefined lifespan, then they are removed from the list of identities. If a unit scans and receives an identity that is found in the stored list, it will abstain from responding. This prevents units from repeatedly responding to inquirers that they already met.

If a unit decides to respond to an inquiry message, two issues are of importance. First, the response message should reveal sufficient information about the respondent such that the inquirer can establish a connection via paging. Second, a mechanism should be used that avoids collisions between different respondents. The latter can be accomplished by randomizing the return transmission.

To be able to page a Bluetooth® unit, the inquiry needs to have the BD_ADDR of the respondent. This information is embedded in a Bluetooth® FHS packet and this packet can be used as a response message. Clock information may not be needed, assuming that the Bluetooth® clock is initialized based on the frame number of the cellular air interface that is known at both sides.

To randomize the return transmissions one could define a response window after the inquiry message. An example is shown in FIG. 6. After the slot used to send the inquiry message 500 at the first wake-up event 601, a response window 610 containing M slots is defined. In FIG. 6, it is assumed that M=3 and that the response window 610 has three response slots 611, 612, 613. A unit that needs to return an FHS packet to the inquirer randomly selects one of the M response slots 611, 612, 613 in order to transmit its FHS packet 650. After sending the inquiry message 500, the inquirer needs to listen to the channel for M more slots in order to collect all responses.

In an alternative embodiment, a single response slot is defined, but the unit waits for a random number L of inquiry messages with the same identity before it returns a response message. This will of course increase the latency because on average the unit will wait for

$$\frac{L}{2} \times {T}_{i}$$

before it responds. This latter embodiment is not shown.

In yet another embodiment, a random access scheme is used. One such example is a contention-resolution scheme.

As was shown in FIGS. 4 and 6, the wake-up instants are carried out at different frequencies, f₀, f₁ and so on. As in the Bluetooth® system, one can define an inquiry hopping sequence. This is a specific pattern of frequency carriers over which the transceivers hop during an inquiry procedure. Since there will now be no frequency uncertainty, the number of hop carriers and the length of the sequence has no impact on the performance of the new techniques described herein. In Bluetooth® systems, the Bluetooth® clock (a free-running clock running at 1600 ticks/s) determines the phase of the sequence. In accordance with another aspect of the invention, the frame number of the cellular system can serve as the clock for the FH carrier selection. As long as the frame duration is smaller than Tᵢ, a new frequency is selected for each new wake-up event. Using different frequencies provides frequency diversity, which in turn provides robustness in an environment where there is interference and where propagation conditions may vary (fading).

When an inquirer has received a response message as described before, it can carry out a paging procedure. In some embodiments, this can be carried out in the conventional way, relying on the free-running clocks available in the Bluetooth® hardware and further described in the Bluetooth® specifications. This requires Bluetooth® clock information to be carried in the response message.

Alternatively, one could reuse the cellular clock for a fast page procedure. Two embodiments are now described. In a first embodiment, the inquirer waits until the next wake-up event. Instead of scanning or sending an inquiry message, it sends a page message to the unit that it wants to connect to. The hop frequency is determined by the inquiry hop sequence and the cellular clock that determines the phase in this sequence. However, instead of an inquiry response procedure, the page response procedure is carried out using the conventional techniques described in the Bluetooth specification. The Bluetooth® clock is initialized with the cellular frame number and is subsequently incremented at a rate of 1600 ticks/s. This limits the inquirer to page one unit every time period T_{w} (one per second in the example described above).

Alternatively, page slots can be defined just after the response window 610 in FIG. 6. These page slots may have a fixed offset with respect to the response slots. Yet, the time duration between the page slots must be sufficiently large to permit the exchange of a number of Bluetooth® packets. Only units that have sent a response message in one of the response slots 611, 612, 613 need to listen for a page message in the corresponding page slot.

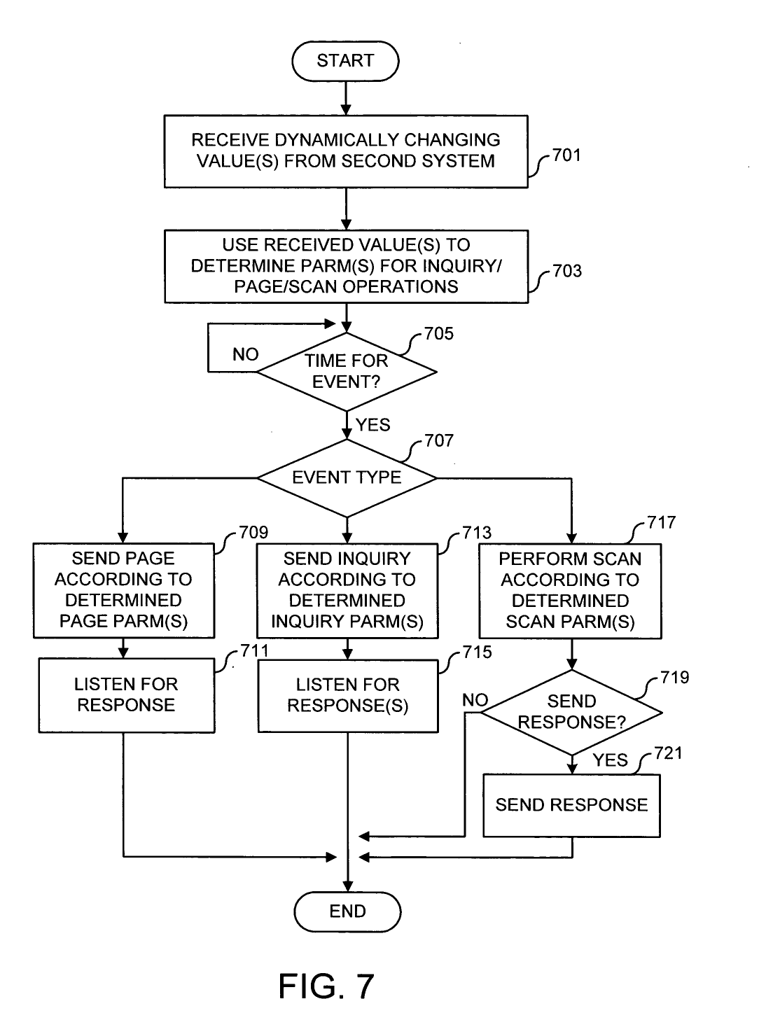

To further illustrate various aspects of the invention, FIG. 7 is an exemplary high-level flow diagram of operations that are performed in a terminal unit, such as any of the exemplary terminal units 120, 140, 160. It will be understood that the terminal unit includes circuitry and control logic for establishing and maintaining communications via a first system, namely a short-range, ad-hoc network, such as (but not limited to) those in accordance with Bluetooth® standards. The terminal unit also includes circuitry and control logic for establishing and maintaining communications with a second system, namely an infrastructure supporting a mobile communication network, such as a cellular telephone network. The circuitry associated with these first and second systems within the terminal are arranged to exchange pertinent information, as described and illustrated earlier with reference to FIG. 3.

An initial action is circuitry associated with the first system receiving one or more dynamically changing values from circuitry associated with the second system (step 701). In the above-described embodiments, these values are exemplified by clock values and/or frame count values from the mobile communications system. As explained earlier, these values are useful because they are also available to other terminal units in the vicinity of this terminal unit, and can therefore be used to synchronize the operation of these units with respect to their operation on the first system (i.e., the ad-hoc short-range network).

Having obtained the one or more dynamically changing values, they are then used to determine one or more parameters that characterize what are herein referred to as ad-hoc communication establishment operations (step 703). By this is meant such operations as an inquiry operation, a paging operation, and a scan operation, since each of these is involved in establishing an ad-hoc communication between units: the inquiry operation enables one unit to discover the presence of one or more other units; the paging operation enables a unit to communicate with an already-known other unit; and the scan operation enables a unit listen for the inquiries and pages of other units, and to respond accordingly.

The particular parameters determined in step 703 may vary from one application to another. In embodiments described above, it was shown how using the second system's clock value could be used to determine a wake-up event time in the first system. Since all units in the vicinity of this terminal would use the same clock value to determine the same wake-up event time, the timing uncertainty of such events is eliminated in the first system.

Another parameter that characterizes ad-hoc communication establishment operations is the particular frequency to be used during a wake-up event in the first system. As described earlier, the second system's clock (e.g., a frame counter value) can be used by all of the terminal units within the vicinity of one another to determine on which frequency the wake-up event will occur, thereby eliminating the frequency uncertainty in the first system.

Of course, maximum benefits would be achieved by using the second system's dynamically changing value(s) to determine both the wake-up time and the frequency for use in performing the wake-up event, but this is not considered to be essential to practicing the invention.

Having determined the one or more parameters that characterize the ad-hoc communication establishment operations, the terminal unit then determines whether it is time for the wake-up event to occur (decision block 705). If not (“NO” path out of decision block 705), then waiting continues. If it is time for the wake-up event to occur (“YES” block out of decision block 705), then what happens next will depend on which wake-up event the terminal is supposed to perform (decision block 707). As explained earlier, there are a number of techniques that the terminal can use to determine from the second system's dynamically changing value(s) not only when it should wake up to perform a scan operation, but also to schedule its inquiry and/or paging procedures (e.g., randomly selecting one out of every L wake-up event times). A discussion of these various embodiments will not be repeated here.

If it is time to perform a paging operation, then the terminal uses the event wake-up time to send a paging message to another unit in the first system (step 709). The terminal then listens for a response (step 711). As explained earlier, there are a number of ways that the timing of the response window can be determined—this discussion will therefore not be repeated here.

If it is instead time to perform an inquiry operation, then the terminal uses the event wake-up time to send an inquiry message to another unit in the first system (step 713). The terminal then listens for responses (step 715). As explained earlier, there are a number of ways that the timing of the response window can be determined—this discussion will therefore not be repeated here.

If it is instead time to perform a scanning operation, then the terminal uses the event wake-up time to scan the determined frequency for either a paging message or an inquiry message sent from another unit in the first system (step 717). In some embodiments, such as those in accordance with Bluetooth® standards, step 717 can involve scanning for both paging and inquiry messages simultaneously. The scan operation can have a duration that is approximately equal to the duration of one inquiry message. The designer may choose not to make the duration of the scan operation exactly equal to the duration of one inquiry message because, in practice, there may be some timing uncertainty left (e.g., due to sliding clocks), so that a little slack in the window is beneficial. Furthermore, when the inquiry message makes use of the more extended format as shown in FIG. 5, the minimum scan window is a little more than the duration of the access code. If no access code is received, it is concluded that no inquiry message was sent. However, if the access code is received, then the receiver remains awake to receive the rest of the packets. Thus, the phrase “approximately equal” is used here to show the relationship between the duration of the scan operation and the amount of time needed to process one inquiry message. The important point is that, due to the substantial elimination of timing uncertainty, it is unnecessary to design the scan operation to be so long as to be able to cover more than one inquiry message.

Based on the contents of the message received as a result of the scan operation, the terminal unit determines whether it should send a response (decision block 719). If so (“YES” path out of decision block 719), then a response is sent (step 721). As explained earlier, there are a number of ways that the timing of this response transmission can be determined—this discussion will therefore not be repeated here.

The invention has been described with reference to particular embodiments. However, it will be readily apparent to those skilled in the art that it is possible to embody the invention in specific forms other than those of the embodiment described above.

For example, the benefits of synchronizing ad-hoc connections are not limited to ad-hoc communication establishment operations. Such operations are just a subset of the more general category of what are herein referred to as ad-hoc communication operations. Other examples of ad-hoc communication operations are communications that take place between networks while they are both in connection mode. Synchronizing different ad-hoc networks can also be applied in these circumstances to achieve improvements. For example, in Bluetooth® networks, a piconet channel is established on a frequency-hopping channel, with the hop sequence and the phase in this sequence being determined by the identity and the clock of the master of the piconet, respectively. The master clock is derived from a free-running clock that is embedded in each Bluetooth® transceiver. A time-slotted channel is defined wherein each slot corresponds to a dwell time of a hop. Different piconets will have different masters with different identities and different clocks. Consequently, these piconets will be independent of one another with respect to the hopping sequences and timing.

Slave units can participate in different piconets by applying time division multiplexing. For one moment in time they use the parameters of master A of piconet A to participate on piconet A; then, for another moment, they use the parameters of master B of piconet B to participate on piconet B. This is also called inter-piconet communications. An extensive explanation of Bluetooth® piconets and inter-piconet communications is given in “BLUETOOTH—the universal radio interface for ad hoc, wireless connectivity,” by J. C. Haartsen, Ericsson Review, No. 3, 1998.

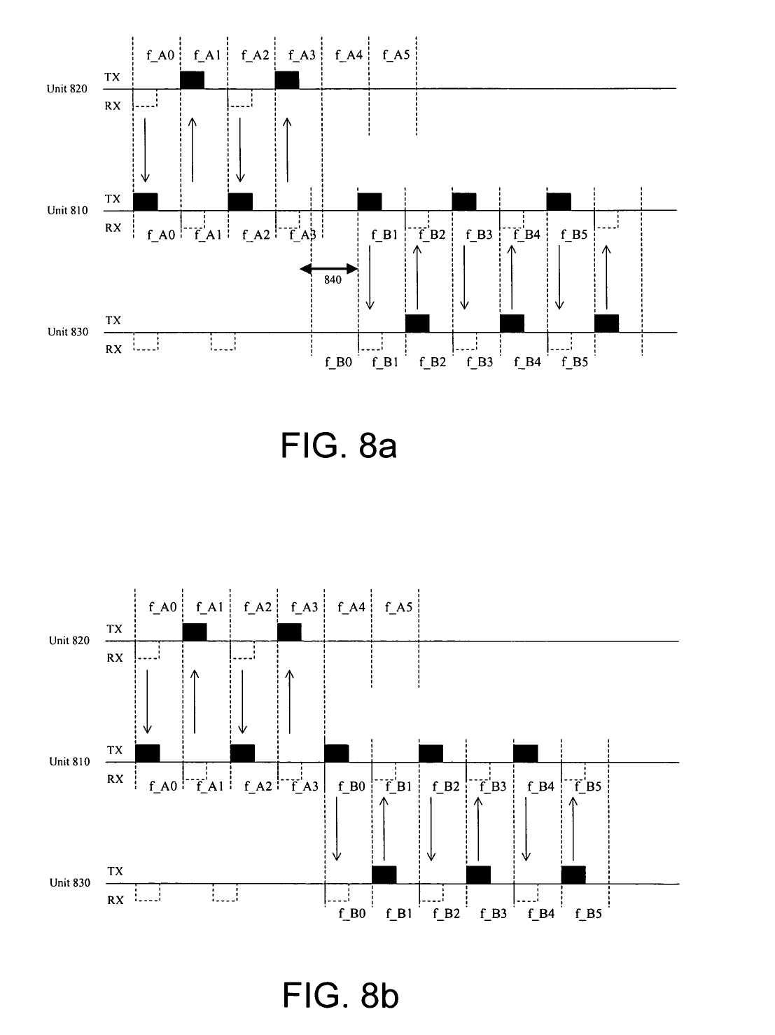

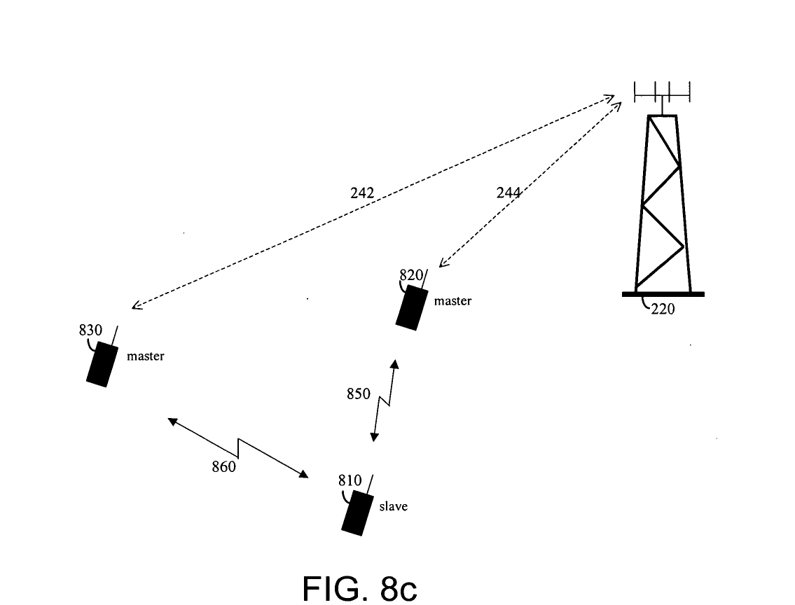

Since different piconets are usually not time synchronized, the time slots of the different piconets are not aligned with one another. Guard times are required to overcome these misalignments. This is illustrated in the timing diagram of FIG. 8A, which shows a slave 810 that is participating in each of two piconets, denoted A and B. Piconet A has a master 820 whose identity and clock determines the timing and hop sequence (e.g., f_{A0}, f_{A1}, f_{A2}, f_{A3}, f_{A4}, f_{A5}, . . . ) of piconet A's FH channel. Piconet B has a master 830 whose identity and clock determines the timing and hop sequence (e.g., f_{B0}, f_{B1}, f_{B2}, f_{B3}, f_{B4}, f_{B5}, . . . ) of piconet B's FH channel. Slave 810 communicates with master 820 for a first time interval on piconet A's FH channel, and then communicates with master 830 during a second time interval on piconet B's FH channel. A guard time 840 is included when the slave 810 switches from communicating with master 820 to communicating with master 830 in order to account for the timing misalignment between the two piconets. A similar guard interval (not shown) is present when the slave switches back from communicating with master 830 to communicating with master 820. Guard times represent extra overhead, which cause a reduction in the throughput. Moreover, due to mutual clock drift, the slotted channels will slide with respect to each other. This will require adaptation of the guard times, as transmission in Bluetooth® networks must always start at a slot boundary. Sliding slots especially pose problems when synchronous services are supported, since these services rely on the ability to deploy packets at a regular interval.

The use of guard times and problems with sliding slots can be prevented when the time slots of the different piconet channels are aligned as illustrated in the timing diagram of FIG. 8B. As with the earlier figure, a slave 810 is shown that is participating in each of two piconets, denoted A and B. Piconet A has a master 820, and piconet B has a master 830. Slave 810 communicates with master 820 for a first time interval on piconet A's FH channel, and then communicates with master 830 during a second time interval on piconet B's FH channel. This will simplify inter-piconet communications drastically. The Bluetooth® clocks of the masters A and B of both piconets are synchronized to the same base station 220 via respective individual cellular channels 242, 244 as is shown in FIG. 8c. FIG. 8c also shows piconet A's FH channel 850 and piconet B's FH channel 860.

Synchronizing the Bluetooth® clocks of the masters A and B of both piconets allows their timing to be aligned. Thus, as shown in FIG. 8b, there is no need for a guard interval when slave 810 switches from communicating with master 820 to communicating with master 830, and vice versa. As a consequence, in this example slave 810 is able to begin communicating in the new piconet one time slot earlier than in conventional techniques.

Additionally, hop sequences can be used which are orthogonal provided the proper phase in the sequence is used. This phase can, for example, be initialized by a common seed derived from the frame counter of the cellular interface.

The described synchronized inter-piconet communications is not limited to a slave participating in two synchronized piconets. Alternatively, a unit can be a master in piconet A and a slave in piconet B. In that case too, synchronization of the piconets improves the communication efficiency.

It is apparent, then, that the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of operating a terminal that is capable of communicating on a first system that is an ad-hoc communication system, and a second system that is a mobile communication system, the method comprising:
receiving one or more dynamically changing values from a network part of the second system; and
using the one or more dynamically changing values to determine one or more parameters that characterize one or more ad-hoc communication operations in the first system.

2. The method of claim 1, wherein the one or more dynamically changing values include a clock value received from the network part of the second system.

3. The method of claim 1, wherein the one or more dynamically changing values include a frame counter value received from the network part of the second system.

4. The method of claim 1, wherein using the one or more dynamically changing values to determine the one or more parameters that characterize one or more ad-hoc communication operations in the first system comprises:
using the one or more dynamically changing values to determine when an ad-hoc communication establishment operation will occur.

5. The method of claim 1, wherein using the one or more dynamically changing values to determine the one or more parameters that characterize one or more ad-hoc communication operations in the first system comprises:
using the one or more dynamically changing values to determine a frequency to be used by the ad-hoc communication establishment operation.

6. The method of claim 1, wherein the ad-hoc communication establishment operation is a scan operation.

7. The method of clam 6, comprising:
performing the scan operation,
wherein the scan operation has a duration that is approximately equal to the duration of one inquiry message.

8. The method of claim 6, comprising:
performing the scan operation and as a result receiving an inquiry message;
determining that a response message should be transmitted in response to the inquiry message; and
selecting one of two or more candidate response time slots for use in transmitting the response message.

9. The method of claim 8, wherein selecting one of the two or more candidate response time slots utilizes a random selection technique.

10. The method of claim 6, comprising:
performing the scan operation and as a result receiving an inquiry message;
determining that a response message should be transmitted in response to the inquiry message; and
using a random access scheme to transmit the response message in a response time slot.

11. The method of claim 10, wherein the random access scheme is a contention-based scheme.

12. The method of claim 6, comprising:
randomly selecting a number, L, representing how many inquiry messages with a same identity must be received before a response message is sent.

13. The method of claim 12, further comprising:
detecting L occurrences of an inquiry message with the same identity, and in response to said detection, transmitting a response message in a response time slot occurring after the L:th inquiry message with the same identity.

14. The method of claim 1, wherein the ad-hoc communication establishment operation is an inquiry operation.

15. The method of clam 14, comprising:
performing the inquiry operation,
wherein the inquiry operation has a duration that is approximately equal to the duration of one inquiry message.

16. The method of claim 14, wherein using the one or more dynamically changing values to determine the one or more parameters that characterize one or more ad-hoc communication operations in the first system comprises:
using the one or more dynamically changing values to determine when the inquiry operation will occur.

17. The method of claim 16, wherein determining when the inquiry operation will occur comprises:
determining a set of two or more candidate wake-up event times;
selecting one of the two or more candidate wake-up event times for use as a wake-up time when the inquiry operation will occur; and
designating all remaining ones of the set of two or more candidate wake-up event times as times when the inquiry operation will not be performed.

18. The method of claim 17, wherein selecting one of the two or more candidate wake-up event times utilizes a random selection technique.

19. The method of claim 16, wherein determining when the inquiry operation will occur comprises:
assigning a probability 1/N that represents a frequency with which the inquiry operation will occur; and
at each occurrence of a candidate wake-up event time, randomly determining whether to perform the inquiry operation such that the inquiry operation will be performed, on average, 1/N of the times that the random determination is made.

20. The method of claim 1, wherein the ad-hoc communication establishment operation is a paging operation.

21. The method of clam 20, comprising:
performing the paging operation,
wherein the paging operation has a duration no longer than the duration of one paging message.

22. The method of claim 20, wherein using the one or more dynamically changing values to determine the one or more parameters that characterize one or more ad-hoc communication operations in the first system comprises:
using the one or more dynamically changing values to determine when the paging operation will occur.

23. The method of claim 22, wherein determining when the paging operation will occur comprises:
using the one or more dynamically changing values to determine when an inquiry operation will occur; and
determining that the paging operation will occur a predetermined time after the time determined for performing the inquiry operation.

24. The method of claim 1, comprising:
while continuing to participate in the first system, using the one or more dynamically changing values to determine one or more parameters that characterize one or more ad-hoc communication operations in a third system, wherein the third system is an ad-hoc communication system.

25. The method of claim 24, wherein:
using the one or more dynamically changing values to determine the one or more parameters that characterize one or more ad-hoc communication operations in the first system comprises using the one or more dynamically changing values to determine a time slot alignment within the first system; and
using the one or more dynamically changing values to determine the one or more parameters that characterize one or more ad-hoc communication operations in the third system comprises using the one or more dynamically changing values to determine a time slot alignment within the third system.

26. The method of claim 25, wherein the time slot alignment within the first system and the time slot alignment within the third system are the same.

27. The method of claim 24, wherein:
using the one or more dynamically changing values to determine the one or more parameters that characterize one or more ad-hoc communication operations in the first system comprises using the one or more dynamically changing values to determine a hop sequence within the first system; and
using the one or more dynamically changing values to determine the one or more parameters that characterize one or more ad-hoc communication operations in the third system comprises using the one or more dynamically changing values to determine a hop sequence within the third system.

28. The method of claim 27, wherein the hop sequence within the first system and the hop sequence within the third system are orthogonal to one another.

29. The method of claim 24, comprising:
performing slave ad-hoc communication operations in the first system while concurrently performing slave ad-hoc communication operations in the third system.

30. The method of claim 24, comprising:
performing master ad-hoc communication operations in the first system while concurrently performing slave ad-hoc communication operations in the third system.

31. An apparatus for operating a terminal that is capable of communicating on a first system that is an ad-hoc communication system, and a second system that is a mobile communication system, the apparatus comprising:
logic that receives one or more dynamically changing values from a network part of the second system; and
logic that uses the one or more dynamically changing values to determine one or more parameters that characterize one or more ad-hoc communication operations in the first system.

32. The apparatus of claim 31, wherein the one or more dynamically changing values include a clock value received from the network part of the second system.

33. The apparatus of claim 31, wherein the one or more dynamically changing values include a frame counter value received from the network part of the second system.

34. The apparatus of claim 31, wherein the logic that uses the one or more dynamically changing values to determine the one or more parameters that characterize one or more ad-hoc communication operations in the first system comprises:
logic that uses the one or more dynamically changing values to determine when an ad-hoc communication establishment operation will occur.

35. The apparatus of claim 31, wherein the logic that uses the one or more dynamically changing values to determine the one or more parameters that characterize one or more ad-hoc communication operations in the first system comprises:
logic that uses the one or more dynamically changing values to determine a frequency to be used by the ad-hoc communication establishment operation.

36. The apparatus of claim 31, wherein the ad-hoc communication establishment operation is a scan operation.

37. The apparatus of clam 36, comprising:
logic that performs the scan operation,
wherein the scan operation has a duration that is approximately equal to the duration of one inquiry message.

38. The apparatus of claim 36, comprising:
logic that performs the scan operation and as a result receives an inquiry message;
logic that determines that a response message should be transmitted in response to the inquiry message; and
logic that selects one of two or more candidate response time slots for use in transmitting the response message.

39. The apparatus of claim 38, wherein the logic that selects one of the two or more candidate response time slots utilizes a random selection technique.

40. The apparatus claim 36, comprising:
logic that performs the scan operation and as a result receiving an inquiry message;
logic that determines that a response message should be transmitted in response to the inquiry message; and
logic that uses a random access scheme to transmit the response message in a response time slot.

41. The method of claim 40, wherein the random access scheme is a contention-based scheme.

42. The apparatus of claim 36, comprising:
logic that randomly selects a number, L, representing how many inquiry messages with a same identity must be received before a response message is sent.

43. The apparatus of claim 42, further comprising:
logic that detects L occurrences of an inquiry message with the same identity, and in response to said detection, transmits a response message in a response time slot occurring after the L:th inquiry message with the same identity.

44. The apparatus of claim 31, wherein the ad-hoc communication establishment operation is an inquiry operation.

45. The apparatus of clam 44, comprising:
logic that performs the inquiry operation,
wherein the inquiry operation has a duration that is approximately equal to the duration of one inquiry message.

46. The apparatus of claim 44, wherein the logic that uses the one or more dynamically changing values to determine the one or more parameters that characterize one or more ad-hoc communication operations in the first system comprises:
logic that uses the one or more dynamically changing values to determine when the inquiry operation will occur.

47. The apparatus of claim 46, wherein the logic that determines when the inquiry operation will occur comprises:
logic that determines a set of two or more candidate wake-up event times;
logic that selects one of the two or more candidate wake-up event times for use as a wake-up time when the inquiry operation will occur; and
logic that designates all remaining ones of the set of two or more candidate wake-up event times as times when the inquiry operation will not be performed.

48. The apparatus of claim 47, wherein the logic that selects one of the two or more candidate wake-up event times utilizes a random selection technique.

49. The method of claim 46, wherein the logic that determines when the inquiry operation will occur comprises:
logic that stores a probability 1/N that represents a frequency with which the inquiry operation will occur; and
logic that, at each occurrence of a candidate wake-up event time, randomly determines whether to perform the inquiry operation such that the inquiry operation will be performed, on average, 1/N of the times that the random determination is made.

50. The apparatus of claim 31, wherein the ad-hoc communication establishment operation is a paging operation.

51. The apparatus of claim 50 comprising:
logic that performs the paging operation,
wherein the paging operation has a duration no longer than the duration of one paging message.

52. The apparatus of claim 50, wherein the logic that uses the one or more dynamically changing values to determine the one or more parameters that characterize one or more ad-hoc communication operations in the first system comprises:
logic that uses the one or more dynamically changing values to determine when the paging operation will occur.

53. The apparatus of claim 52, wherein the logic that determines when the paging operation will occur comprises:
logic that uses the one or more dynamically changing values to determine when an inquiry operation will occur; and
logic that determines that the paging operation will occur a predetermined time after the time determined for performing the inquiry operation.

54. The apparatus of claim 31, comprising:
logic that, while the apparatus continues to participate in the first system, uses the one or more dynamically changing values to determine one or more parameters that characterize one or more ad-hoc communication operations in a third system, wherein the third system is an ad-hoc communication system.

55. The apparatus of claim 54, wherein:
the logic that uses the one or more dynamically changing values to determine the one or more parameters that characterize one or more ad-hoc communication operations in the first system comprises logic that uses the one or more dynamically changing values to determine a time slot alignment within the first system; and
the logic that, while the apparatus continues to participate in the first system, uses the one or more dynamically changing values to determine the one or more parameters that characterize one or more ad-hoc communication operations in the third system comprises logic that, while the apparatus continues to participate in the first system, uses the one or more dynamically changing values to determine a time slot alignment within the third system.

56. The apparatus of claim 55, wherein the time slot alignment within the first system and the time slot alignment within the third system are the same.

57. The apparatus of claim 54, wherein:
the logic that uses the one or more dynamically changing values to determine the one or more parameters that characterize one or more ad-hoc communication operations in the first system comprises logic that uses the one or more dynamically changing values to determine a hop sequence within the first system; and
the logic that, while the apparatus continues to participate in the first system, uses the one or more dynamically changing values to determine the one or more parameters that characterize one or more ad-hoc communication operations in the third system comprises logic that, while the apparatus continues to participate in the first system, uses the one or more dynamically changing values to determine a hop sequence within the third system.

58. The apparatus of claim 57, wherein the hop sequence within the first system and the hop sequence within the third system are orthogonal to one another.

59. The apparatus of claim 54, comprising:
logic that performs slave ad-hoc communication operations in the first system while concurrently performing slave ad-hoc communication operations in the third system.

60. The apparatus of claim 54, comprising:
logic that performs master ad-hoc communication operations in the first system while concurrently performing slave ad-hoc communication operations in the third system.

61. A machine readable storage medium having stored therein a set of program instructions for operating a terminal that is capable of communicating on a first system that is an ad-hoc communication system, and a second system that is a mobile communication system, the set of program instructions causing a processor to control logic within the terminal to perform:
receiving one or more dynamically changing values from a network part of the second system; and
using the one or more dynamically changing values to determine one or more parameters that characterize one or more ad-hoc communication operations in the first system.
